(19) United States
(12) Patent Application Publication
(10) Pub. No.: US 2008/0204556 A1
(43) Pub. Date: Aug. 28, 2008

(54) Vehicle camera security system

(76) Inventors: Federico Thoth Jorge de Miranda, Tulsa, OK (US); Patricio Jorge, New Bedford, MA (US)

Correspondence Address: David J. Rotondo, Esq.;The Bates Bldg., Suite 219A, 7North Main Street, Attleboro, MA, 02703, US

(21) Appl. No.: 11/710,166

(22) Filed: Feb. 23, 2007

(51) Int. Cl. H04N 7/18

(52) U.S. Cl. 348/148; 348/E07.085

(57) ABSTRACT

An automotive vehicle anti-theft, anti-vandalism and anti-carjacking system utilizing a visual monitoring system for reducing the incidence of theft or vandalism of an automotive vehicle and an emergency notification system is disclosed. The monitoring system comprises a plurality of video cameras mounted interior and exterior to the vehicle and interfacing electronics within the vehicle adapted for detecting motion exterior to the vehicle and video recording in the direction of the detected motion. The system comprises interior RF video cameras positioned adjacent to the interior front and rear windshields and exterior video cameras placed within the left and right side mirrors. The system is capable of providing visual monitoring data to a mobile communications device via a wireless internet connection or to a wireless dedicated monitor via a Radio Frequency (RF) link.

### FIELD OF THE INVENTION

This invention relates in general to certain new and useful improvements in automotive vehicle anti-theft systems and more particularly, to an automotive vehicle monitoring system utilizing video cameras located both interior and exterior to the vehicle for realtime alert and recording of potential theft, vandalism, and accidents that are motion detected within the immediate vicinity of the vehicle.

### BACKGROUND OF THE INVENTION

In recent years, the incidence of automotive vehicle theft has increased dramatically, particularly with the availability of very high-cost automotive vehicles. For example, in recent years, it is not uncommon to find numerous automotive vehicles where the sales cost easily exceeds $50,000.00 to $150,000.00. As a result, there has been an increasingly available black market for stolen automotive vehicles which may be either resold or otherwise stripped for parts.

In addition to the increase in theft, there has also been a substantial increase in the amount of vandalism to automotive vehicles. While the precise cause of the vandalism are relatively uncertain, the fact remains that there has been a substantial increase in vandalism associated with many vehicles giving rise in increased number of insurance clams and higher insurance premium costs.

In order to reduce the incidence of automobile vehicle theft and vandalism, there have been numerous proposed alarm systems. A majority of these alarm systems operate on the basis of a vibration sensor or similar sensor which will detect the presence of a person attempting to open the vehicle or otherwise gain unauthorized access to the vehicle. In many cases, these vehicle alarm systems are not effective because the owner or user of the vehicle is located at a remote location.

As a simple example, if a vehicle is in a parking lot, it is virtually impossible for the owner or user of the vehicle to hear a generated alarm. While the alarm itself may attract passerby population, the average thief can still start the vehicle and drive away before anyone assumes the presence of mind to call the police or otherwise, take some positive action.

Notwithstanding the foregoing, even if the owner or the user of an automotive vehicle was in close enough proximity to hear a vehicle alarm, this owner or user is frequently unaware if that alarm is one from his or her vehicle. Due to the fact that many automotive vehicles are equipped with alarm systems, it is virtually impossible to determine if the sound of that alarm emanates from the owner's or user's vehicle or another vehicle.

There exists a need for an automobile alarm and notification system that is aesthetically pleasing and cost effective utilizing the current state of video surveillance technology. Furthermore, it is desirable to provide a system that can utilize wireless internet technology, wireless video, and mobile communications devices to provide realtime video monitoring and alerting. This type of system would enable an operator to park his vehicle and activate a vehicle monitoring system utilizing video cameras located both interior and exterior to the vehicle. The monitoring system would alert the operator and provide video of potential theft, vandalism, and accidents that are motion detected within the immediate vicinity of the vehicle.

### SUMMARY OF THE INVENTION

The present Vehicle Camera Security System utilizes wireless internet technology, wireless video, and mobile communications devices to provide realtime video monitoring and alerting. The system enables an operator to park his vehicle and activate a vehicle monitoring system utilizing video cameras located both interior and exterior to the vehicle. The monitoring system would alert the operator and provide video of potential theft, vandalism, and accidents that are motion detected within the immediate vicinity of the vehicle.

Specifically, the system utilizes low LUX wireless video cameras that are mounted within the side mirrors of a vehicle that are capable of recording video from the sides of the vehicle when the mirror is in either the stored or open position. Low LUX cameras are also provided at the front and rear of the vehicle for forward and rear video recording. The video cameras become enabled after the operator parks and exits the vehicle and are activated upon the detection of motion in the direction of a selected camera.

Upon activation the cameras provide a high frequency low power analog output to system controller electronics located within the vehicle. The system controller converts the images to a digital stored format that is managed by system controller software and alerts the user by wireless link that motion has been detected. The video images are then available to be uploaded via a users dedicated monitor or through a wireless communications device.

### BRIEF DESCRIPTION OF THE DRAWINGS

The invention is best understood from the following detailed description when read in connection with the accompanying drawings, which illustrate an embodiment of the present invention:

FIG. 1 illustrates a motor vehicle utilizing the present invention.

FIG. 2 illustrates a front view of the motor vehicle of FIG. 1 with a video camera placed within the interior of the front vehicle windshield.

FIG. 3 illustrates a front view of the motor vehicle of FIG. 1 with a video camera placed within the vehicle front bumper.

FIG. 4 illustrates a rear view of the motor vehicle of FIG. 1 with a video camera placed within the interior of the rear vehicle windshield.

FIG. 5 illustrates a rear view of the motor vehicle of FIG. 1 with a video camera placed along the vehicle rear bumper.

FIG. 6 illustrates a left and right vehicle side mirror incorporating video cameras placed therein and opened to illustrate the placement of the cameras and detail of the mirror design.

FIG. 7 illustrates the left and right mirrors of FIG. 6 with the mirror in an operational position.

FIG. 8 illustrates the left and right mirrors of FIG. 6 with the mirror in the closed position.

FIG. 9 illustrates a system block diagram illustrating the hardware components and system interfaces of subject invention.

FIG. 10 is a flowchart of the method of operation of subject invention that is embodied in software or firmware that is hosted within hardware components of FIG. 9.

### DETAILED DESCRIPTION OF THE INVENTION

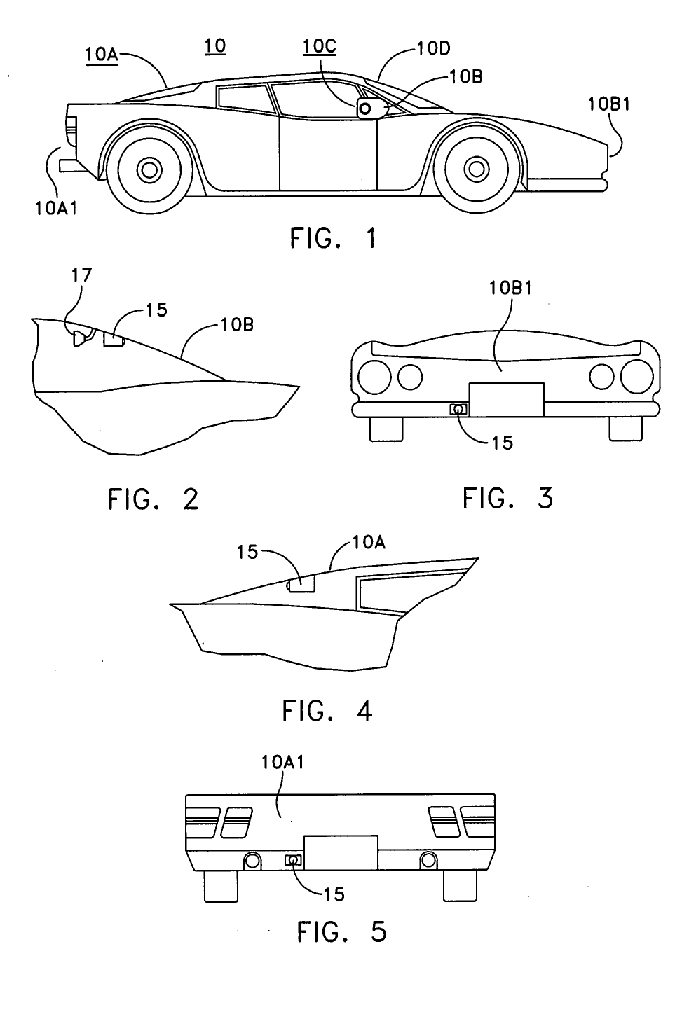

Referring to FIGS. 1-6, a vehicle 10 is disclosed illustrating the location of vehicle security cameras 15. Referring to FIG. 2, a camera 15 is located at the interior of the front windshield 10B, behind the vehicle mirror 17. Alternatively, this camera 15 could be placed in a position within the front bumper assembly 10B1 as in FIG. 3. Referring to FIG. 4, a camera 15 is located at the interior of rear windshield 10A.

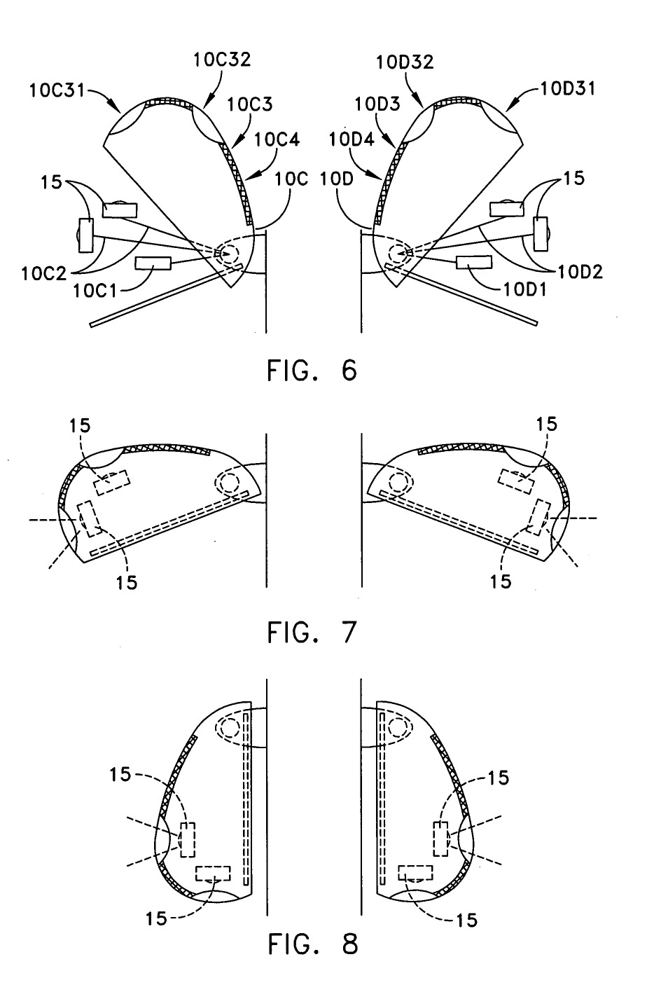

Alternatively, this camera 15 could be place in a position along the rear bumper 10A1 as illustrated in FIG. 5. Referring to FIGS. 6 and 7 a first camera 15 and a second camera 15 are mounted internal to left and right vehicle mirrors 10C and 10D. Mirrors 10C and 10D have identical structure and are of the type that can be utilized as a blinker. Transparent material 10C3 integrated into outer casing 10C4 is illuminated by bulb 10C1 when the blinker function is activated in vehicle 10.

Outer casing 10C4 of mirrors 10C and 10D further include lenses 10C31 and 10C32 to coincide with the focal position of first and second cameras 15. It is understood that lenses 10C31 and 10C32 may be convex or of other configuration necessary to compliment cameras 15 for acceptable range of detection and recording and is known in the optics art. First and second cameras 15 are positioned within the interior of mirror 10C such that video recording of motion detected to the left and right sides of the vehicle 10 can be accomplished when the vehicle mirrors 10C and 10D are in an operational position as illustrated in FIG. 7 or in the stored position as illustrated in FIG. 8.

It is understood that depending on the detection sweep of cameras 15 fewer or more cameras 15 may be necessary to cover a desired range of detection. It is further understood that cameras 15 utilizing rotating or panning camera lenses (described hereinafter) may be utilized and reduce the total number of cameras required.

Cameras 15 are well known in the art and are low LUX (Measurement of low light needed to view and record properly) cameras, can at a minimum record black and white video, are capable of capturing video in a nighttime environment, and have a high wireless transmit/receive frequency. Transmit frequencies above two GHZ are known in the art to transmit video from such low Lux cameras. Cameras 15 utilize CMOS or CCD component circuitry such that the dimensions of the cameras are small enough to allow for placement within vehicle mirrors 10C and 10D.

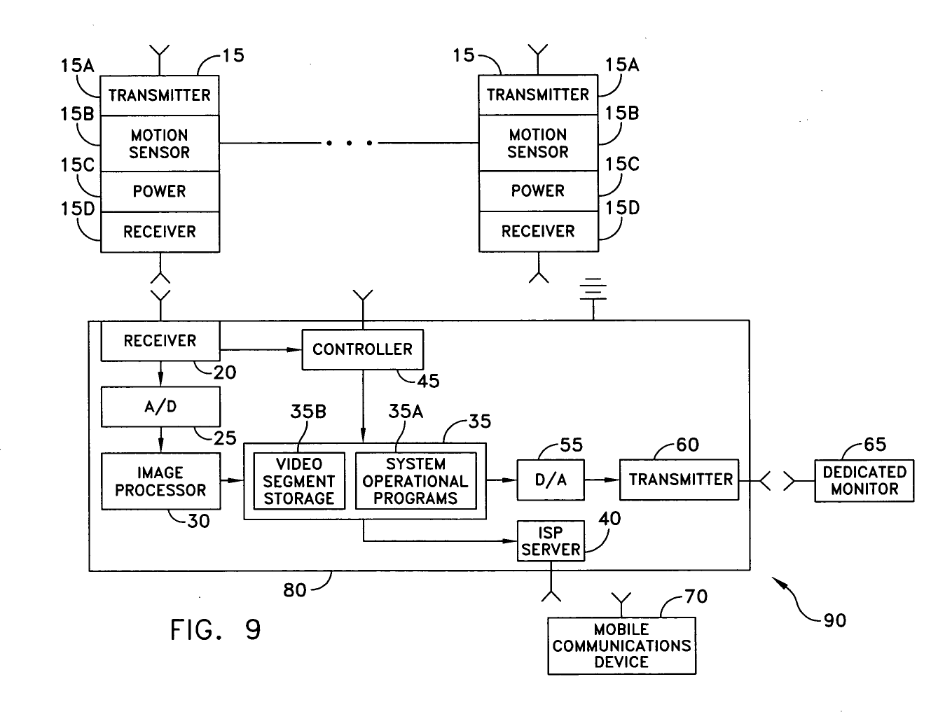

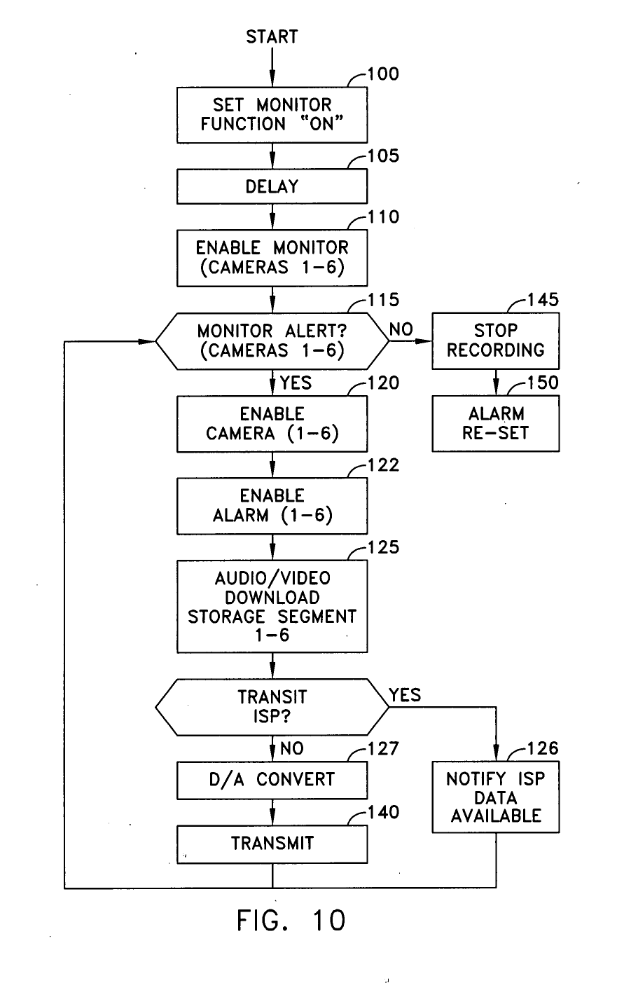

Referring to FIG. 9, each camera 15 utilized in vehicle camera security system 90 includes an audio/video transmitter 15A, motion sensor 15B, power source 15C, and a receiver 15D. Transmitter 15A has a low power output sufficient to transmit audio/video signals to signal processing hardware 80 located within vehicle 10. The hardware 80 can be located in the vehicle trunk or other accessible hidden location and is hardwired to the vehicle 10 car battery power source.

Camera 15 further includes a motion sensor 15B utilized to activate transmitter 15 audio/video transmit function upon the detection of motion and a receiver 15D utilized for receiving camera 15 enable commands from signal processing hardware 80. Motion sensor 15B shall be programmable for motion detection at user defined distances. Camera 15 may comprise features of cameras known in the art such as rotating or panning camera 15 lenses that are capable of changing the viewing angle based on the direction of motion that activates transmitter 15 audio/video transmit function. Due to the low power output of camera 15 power source 15C can be battery power or power can be hardwired to each camera 15 from a source within vehicle 10.

Referring to FIG. 9, signal processing hardware 80 comprises a receiver 20 adapted to receive audio/video signals from transmitter 15A. Receivers 20 are known in the art. One example of such a receiver 20 has an RF input in the range of 2411 to 2483 MHZ, sufficient frequency stability of ±250 KHZ, and is PLL frequency synthesized. Signal processing hardware 80 further comprises an analog to digital converter (A/D) 25 for conversion of analog video stream data to a digital format.

A/D converters are known in the art. One example of such an A/D converter 25 is capable of 640×480 resolution motion capture capability. The motion capture capability of subject invention should be of sufficient resolution to allow for identification of the individual or vehicle that is detected. Other motion capture video formats and frame rates within the scope of the present invention include, at a minimum, 352×288 (25-30 fps), 320×240 (30 fps), 176×144 (30 fps), and 160×120 (30 fps).

Signal processing hardware 80 further comprises an image processor 30 capable of compressing video/image data in accordance with standard compression algorithms known in the art, such as MPEG or equivalent formats known in the art to support realtime image output. Controller 45 includes system processor hardware and software applications capable of supporting realtime processing of audio/video data, and are known in the art, such as, 512 MB RAM, and a 266 MHZ Pentium processor.

Storage device 35 comprises a 1 Gigabyte or more hard drive for video storage 35B. Storage device 35 is also utilized to store system operational programs 35A, described hereinafter, and video instant messaging applications such as AIM, Yahoo messenger, MSN messenger etc. It is understood that other commercially available applications programs designed for retrieving, displaying and archiving audio/video data via a mobile communications device 70 may be utilized in subject invention and implemented in signal processing hardware 80.

Signal processor hardware 80 further includes digital to analog (D/A) converter 55 for converting stored digital data back to analog output and is known in the art. Transmitter 60 outputs the data streams from D/A converter 55 at a transmit frequencies above two GHZ. Transmitter 60 can have a high output power for maximum range in accordance with maximum allowable power output in accordance with Federal Communications Commission (FCC) regulations.

Transmitter 40 includes a video server configured to transmit over a wireless internet service (ISP) which is compatable with a current mobile communication device 170 operation. Mobile device 70 is known in the art and is an internet equipped access mobile phone, PDA, or blackberry for retrieving posted pictures from a user website, receiving real time audio/video, and receiving instant messaging alerts upon camera 15 activation. In this configuration, standard Internet Protocol (IP) addressing between transmitter 40 and device 70 would be utilized and the specific method of subject invention, herinafter described, would be supported by the service provider.

Dedicated monitor 65 is an analog video receiver having an RF range of 2411-2483 MHZ, sufficient frequency stability ±250 KHZ, and is PLL Frequency Synthesized. Monitor 65 would be packaged for portable use (handheld), have a realtime video monitoring capability and include a notification feature which would alert the user (Beep or vibrate) upon receipt of analog signals from transmitter 60.

Referring to FIG. 10 a flow chart is illustrated depicting a method of providing realtime video for the vehicle security system 90 of the present invention. FIG. 10 depicts the method of providing realtime analog video. It is understood that this method may be implemented through a combination of computer hardware and software associated with vehicle security system 90, such as that depicted in FIG. 9.

In the embodiment disclosed in the present invention, wireless video cameras and associated hardware would be configured in a vehicle 10 as previously described. The security system of the present invention is intended to operate when the vehicle is parked or stationary or alternatively, can be programmed to operate while the vehicle is in motion.

Referring to FIG. 10, in a typical scenario, upon entering vehicle 10 the system would be disabled. The system would only be enabled when a monitor function switch is activated 100. The monitor function switch could be a simple timed relay configured to enable or disable power to cameras 15 and signal processing hardware 80 when the monitoring function switch is activated. The monitor function is delayed a period of time 105 to give the occupants of the vehicle time to get out of the vehicle and out of range of the video camera 15 motion detectors.

Alternatively, a second monitor function switch could be activated to allow for recording of audio/video data while the vehicle is in motion. By enabling this second monitor function switch motion sensors 15B would be set to detect motion at a close range (5 ft or less) and cameras 15 would record data as hereinafter described. This configuration of the vehicle security system would allow for recording of audio/video data of accidents while the vehicle is in motion.

In the configuration for monitoring an unoccupied vehicle, the operator, upon exiting his vehicle could adjust his vehicle mirrors 10C and 10D to an open configuration (FIG. 7) or a closed configuration (FIG. 8). Subsequent to the monitor function 100 being set and after delay 105, controller 45 transmits an enable command to cameras 15. The enable command can be an analog or discrete pulsed signal. This enable transmit function is built into controller 45 and is known in the art.

Similarly the receiver 15D would be configured to receive the pulsed signal and is known in the art. The enable command 15 is received by receiver 15D and enables all motion sensors 15B of cameras 15 (110). In the disclosed embodiment, six motion sensors 15B are enabled. At this point the vehicle security system is active, however no video is being transmitted until motion sensors 15B detect motion across their respective sensor ranges (115).

Upon detection of motion from any of the 6 video cameras, that respective camera 15 would be enabled by its corresponding motion sensor 15 (120) and begin transmitting video/audio via transmitter 1SA to receiver 20. Receiver 20 has the capability to receive audio/video data from all six cameras 15 simultaneously if required in the case of multiple motion alerts. Similarly, the analog to digital converter 25, image processor 30, and video segment storage 35 of signal processing hardware 80 are configured to convert, process, and store audio/video data from cameras 1-6 in storage 35 segmented data storage 35B. The hardware 80 is capable of processing data from all cameras simultaneously or each individually when activated.

Upon receipt of data at receiver 20 via cameras 1-6, controller 45 identifies the respective enabled camera 15 (1-6) and allocates the audio/video data stream of Image processor 30 to distinct memory segments 35B numbers 1-6 (125). This stored audio/video data would remain in memory and could be extracted or deleted from memory via controller 45 output for future viewing.

For transmitting analog signals by wireless RF to a dedicated analog monitor 65 the controller would next direct the output of stored audio/video data from segments 35B numbers 1-6 to the digital to analog converter (D/A) 55 (127). For transmitting data via an Internet Service Provider (ISP) controller 45 would notify the ISP server 40 that data is available for downloading (126). Controller 45 will be programmable to select either or both transmit options.

For the ISP transmit function to be utilized a user would have an internet service activated. For analog signals via wireless RF, the analog output from converter 55 is next transmitted by transmitter 60 to a dedicated analog video/audio receiver 65 (140). Upon receipt of the first data segment (any segment 1-6) in video segment storage 35B, controller 45 would enable an alarm bit (122) which would be included in the first segment data stream outputted to D/A converter 55 (127) then to transmitter 60 (140). The alarm bit (now an analog signature) would trigger an alarm circuit (beep, vibrate, etc) at monitor 65 to alert the user of activity around vehicle 10.

The alarm will continuously alert the user (122) until all motion sensors have turned off and no audio/video is being recorded (145). At that time controller 45 will reset the alarm bit (150). Monitor 65 would have the capability to mute the alarm circuit signal if desired. Similarly, a instant messaging applications such as AIM, Yahoo messenger, MSN messenger, as part of an ISP service, could be used to alert the user of activity around vehicle 10.

Such a messaging application could be invoked after data is received in video segment data storage 35B to notify the user that audio/video data is available. Other ISP applications software may be utilized and provide the user the ability to manipulate data uploaded to the ISP server via a cell phone or PDA device.

For both analog signals via wireless RF, and for data for transmission via a wireless ISP, controller 45 operates to sequentially parse through segments 1-6 allowing for timed output of each data segment to D/A converter 55 or ISP 40. Furthermore, controller 45 would skip data segments where no audio/video data exists. This would be in the case of a specific camera not being motion activated. In the disclosed embodiment, data segments 1-4 represent the data from cameras embodied within vehicle camera mirrors 10C and 10D, and data segments 5 and 6 represent the data from vehicle 10 front and rear cameras.

If data is only stored in segments 1, 2 and 6, indicating audio/video activity from left side mirror 10C cameras 15 and one front vehicle camera 15, controller 45 would direct storage 35B to output to the D/A converter 55 or ISP server 40 sequential video from segments 1,2, and 6. The controller would be programmable to allow timed output from each sequential video storage segment 1,2 and 6. For example, if a timed output of five seconds is selected controller 45 would direct storage 35B to output to the D/A converter or ISP server segment 1 for five seconds, then segment 2 for five seconds then segment 3 for five seconds, then back to segment 1 etc.

The controller 45 saves the last position in each video storage segment such that upon retuning to that segment the timed output begins where it left off. In this respect video output from transmitter 60 to wireless RF receiver 65 or video output to ISP 40 cycles through all cameras 1-6 which have been activated. Upon any memory segment 1-6 being stored to capacity the controller would allocate the data stream from image processor 30 to write realtime data over previously recorded data starting from the beginning of the data segments 1-6.

It should be understood that the preceding is merely a detailed description of one embodiment of this invention and that numerous changes to the disclosed embodiment can be made in accordance with the disclosure herein without departing from the spirit or scope of the invention. Rather, the scope of the invention is to be determined only by the appended claims and their equivalents.

We claim:

1. In combination with a motor vehicle, said vehicle having an exterior surface, an interior compartment, a front, and a rear, said vehicle having a front and rear window, a front and rear bumper, and left and right side mirrors, said left and right side mirrors each having a removable outer casing and accessible internal space, said side mirrors each having an internal light source and translucent outer casing, a security system comprising:
a plurality of cameras mounted in conjunction with said vehicle, at least one of said plurality of cameras positioned within said internal space of said left side mirror and said right side mirror, at least one of said plurality of cameras positioned at said front and said rear of said vehicle, said plurality of cameras each having a first analog output signal, said output signal generated upon at least one of said plurality of cameras detecting movement around said vehicle, said plurality of cameras each recording audio and video data upon detection of movement around said vehicle and transmitting said data as said plurality of first analog output signals;
signal processing means positioned within said vehicle interior compartment, said signal processing means for receiving and storing said plurality of first analog output signals digitally, said signal processing means including first conversion means for converting said plurality of first analog output signals to a plurality of digital output signals, said signal processing means further including controller means for directing said plurality of digital output signals to segmented storage space, said signal processing means further including second conversion means for converting said plurality of digital output signals to a plurality of second analog output signals, said signal processing means further including wireless transmit means for transmitting said plurality of second analog output signals; and
monitor means for receiving, processing and displaying said plurality of second analog output signals.

2. A security system as in claim 1, wherein said at least one of said plurality of cameras positioned at said front and said rear of said vehicle are positioned on said front and rear window.

3. A security system as in claim 1, wherein said at least one of said plurality of cameras positioned at said front and said rear of said vehicle are positioned on said front and said rear bumper.

4. A security system as in claim 1, wherein said plurality of cameras further comprise transmit means, receiver means, and motion detection means, said transmit means for transmitting said first analog output signals, said receiver means for receiving an enable command from said controller.

5. A security system as in claim 4, wherein said transmit means is wireless.

6. A security system as in claim 4, wherein said plurality of cameras record both video and audio.

7. A security system as in claim 1, wherein said monitor means is a handheld portable monitor.

8. A security system as in claim 7, wherein said monitor means is selected from the group consisting of cell phones and PDA devices.

9. A security system as in claim 1, wherein said first conversion means further includes image processor means for compressing said plurality of digital output signals prior to said segmented data storage.

10. A security system as in claim 1, wherein said first and second side mirror outer casing further includes at least one lense, said at least one lense coinciding with the focal position of said at least one of said plurality of cameras positioned within said internal space of said left side mirror and said right side mirror.

11. A security system as in claim 1, wherein said controller means further includes camera enable means, said camera enable means for generating an enable command to said plurality of cameras, said enable command for activating said plurality of cameras to record audio and video data upon detection of movement around said vehicle.

12. A security system as in claim 11, wherein said camera enable means further includes wireless transmit means for generating said enable command.

13. A method of providing realtime audio and video from a vehicle alarm system, said vehicle alarm system having a plurality of cameras positioned in the front and rear, and in the left and right side mirrors, said method comprising the steps of:
detecting motion at least one of said plurality of motion sensors contained within at least one of said plurality of cameras;
transmitting first analog audio/video data from said at least one of said plurality of cameras with detected motion to processing hardware located within the vehicle;
converting said first analog audio/video data from said at least one of said plurality of cameras with detected motion to a digital format;
storing said digital formatted data sequentially from at least one of said plurality of cameras with detected motion into a storage location within said processing hardware matched to each of said plurality of cameras;
converting said digitally formatted sequentially stored audio/video data from each of said matched storage locations to a second analog audio/video data;
transmitting said second analog audio/video data converted from said each of said matched storage locations to a remote monitor.

14. The method of providing realtime audio and video from a vehicle alarm system as in claim 13, wherein the step of Converting said first analog audio/video data further includes the step of setting an alarm bit within said digitally formatted data.

15. The method of providing realtime audio and video from a vehicle alarm system as in claim 14, wherein the step of transmitting said second analog data further includes the step of generating an alarm at said remote monitor to notify the user that data is available.

16. The method of providing realtime audio and video from a vehicle alarm system as in claim 13, wherein the step of converting said sequentially stored digitally formatted audio/video data from each of said matched storage locations to a second analog audio/video data for transmission to a remote monitor, further includes the steps of:
sequentially parsing through said matched storage locations from beginning to end continuously;
timing the output of the data within each of said sequentially parsed matched storage locations to be transmitted to said remote monitor;
saving the last position of said timed output whereby upon returning to said matched storage location during said continuous parsing the timed output begins where it left off;
skipping said matched storage locations that contain no data.

17. A method of providing realtime audio and video from a vehicle alarm system, said vehicle alarm system having a plurality of cameras positioned in the front and rear, and in the left and right side mirrors, said method comprising the steps of:
detecting motion at least one of said plurality of motion sensors contained within at least one of said plurality of cameras;
transmitting first analog audio/video data from said at least one of said plurality of cameras with detected motion to processing hardware located within the vehicle;
converting said first analog audio/video data from said at least one of said plurality of cameras with detected motion to a digital format;
storing said digital formatted data from at least one of said plurality of cameras with detected motion into a storage location within said processing hardware matched to each of said plurality of cameras; and
uploading said stored digital formatted data to an ISP server.

18. A method of providing realtime audio and video from a vehicle alarm system as in claim 17, wherein the step of uploading of said stored digital formatted data to an ISP server further includes the steps of:
sequentially parsing through said matched storage locations from beginning to end continuously;
timing the output of the data within each of said sequentially parsed matched storage locations to be uploaded to said ISP server;
saving the last position of said timed output whereby upon returning to said matched storage location during said continuous parsing the timed output begins where it left off;
skipping said matched storage locations that contain no data.

19. The method of providing realtime audio and video from a vehicle alarm system as in claim 13, further comprising the steps of:
setting the monitoring function mode of said vehicle alarm system for recording during vehicle motion or recording when the vehicle is parked;
generating an enable command from said processing hardware within said vehicle to activate said plurality of motion sensors contained within at least one of said plurality of cameras.

20. The method of providing realtime audio and video from a vehicle alarm system as in claim 19, further comprising the step of delaying the generation of said enable command to allow the occupants of the vehicle to exit the vehicle beyond the range of motion detection, said step of delaying performed when said monitoring function mode is set to record when said vehicle is parked.
